(19) United States
(12) Patent Application Publication
(10) Pub. No.: US 2026/0134877 A1
(43) Pub. Date: May 14, 2026

(54) DEVICE AND METHOD FOR AUDIO OBJECT SEPARATION

(71) Applicant: Samsung Electronics Co., Ltd., Suwon-si (KR)

(72) Inventors: Inwoo HWANG, Suwon-si (KR); Dowon KIM, Suwon-si (KR); Dongwoo KIM, Suwon-si (KR); Sunmin KIM, Suwon-si (KR); Hanki KIM, Suwon-si (KR); Yoonjae LEE, Suwon-si (KR); Hyeonsik JEONG, Suwon-si (KR)

(21) Appl. No.: 19/296,004

(22) Filed: Aug. 11, 2025

Related U.S. Application Data
(63) Continuation of application No. PCT/KR2025/011955, filed on Aug. 7, 2025.

(30) Foreign Application Priority Data
Nov. 13, 2024 (KR) 10-2024-0160919

(51) Int. Cl. G10L 21/028; G06F 40/47; G10L 13/02; G10L 21/034; G11B 27/00; H04S 7/00

(52) U.S. Cl. CPC G10L 21/028; G10L 21/034; G11B 27/005; H04S 7/303; G06F 40/47; G10L 13/02; H04S 2400/11; H04S 2420/01

(57) ABSTRACT

The disclosure discloses an electronic device and method for audio object separation. The electronic device may receive first input data including audio data for a first frame, convert the first input data into a frequency domain to obtain first frequency data, and apply an appropriate delay corresponding to a processing time related to the generation of mask data to the first frequency data, obtaining first frequency object data by applying the first mask data generated for audio object separation. The electronic device obtains the first object data by inversely converting the first frequency object data into the time domain.

### CROSS-REFERENCE TO RELATED APPLICATIONS

This application is a continuation of International Application No. PCT/KR2025/011955 designating the United States, filed on Aug. 7, 2025, in the Korean Intellectual Property Receiving Office and claiming priority to Korean Patent Application No. 10-2024-0160919, filed on Nov. 13, 2024, in the Korean Intellectual Property Office, the disclosures of each of which are incorporated by reference herein in their entireties.

### BACKGROUND

### Field

The disclosure relates to an electronic device and method for audio object separation.

### Description of Related Art

Recently, advancements in audio object separation technology have progressed toward the real-time separation and analysis of various objects within increasingly complex environments. Among these, on-device real-time audio object separation technology refers to a method where the user may separate an audio object directly on the device, without a separate cloud connection. These techniques play an important role in various applications such as speech recognition, noise cancellation, speech augmentation, and background noise suppression in real-time environments.

In this audio object separation technology, artificial intelligence models, especially deep learning-based neural network models, are mainly used to analyze audio signals. The neural network model may learn complex audio patterns in the time-frequency domain from sample audio data and separate one or more independent audio objects from the audio signal.

The above-described information may be provided as related art for the purpose of helping understanding of the disclosure. No assertion or determination is made as to whether any of the foregoing is applicable as background art in relation to the disclosure.

### SUMMARY

According to an embodiment of the disclosure, an electronic device may be provided. The electronic device may comprise: an audio input unit, comprising circuitry, memory including at least one storage media storing at least one instruction, and at least one processor, comprising processing circuitry, individually and/or collectively, configured to execute the at least one instruction, and to cause the electronic device to: convert first input data including audio data for a first frame into a frequency domain to obtain first frequency data, generate first mask data for audio object separation using the first frequency data, delay the first frequency data by a first frame delay and apply the delayed frequency data to the first mask data to obtain first frequency object data, and convert the first frequency object data into a time domain to obtain first object data, wherein first frame delay may be a number of frames related to a time taken to generate and apply mask data from the frequency data.

According to an embodiment, at least one processor, individually and/or collectively, may be configured to cause the electronic device to: convert second input data, including audio data including input audio data for the first frame and input at a time following the first input data, into the frequency domain to obtain second frequency data; generate second mask data for audio object separation using the second frequency data, delay the second frequency data by the first frame delay and apply the same to the second mask data, thereby obtaining second frequency object data and converting the same into a time domain to obtain second object data; and perform an overlap between an object data portion for the first frame included in the first object data and an object data portion for the first frame included in the second object data to obtain overlapping object data for the first frame.

According to an embodiment, at least one processor, individually and/or collectively, may be configured to cause the electronic device to: perform an overlap between an audio object data portion for the first frame included in the second object data and an audio object data portion for the first frame included in the first object data to obtain overlapping object data for the first frame, wherein the second object data may be object data obtained before the first object data and include audio object data for the first frame.

According to an embodiment, at least one processor, individually and/or collectively, may be configured to cause the electronic device to perform the overlap by applying at least one window function to the object data portion for the first frame included in the first object data and the object data portion for the first frame included in the second object data and obtain the overlapping object data for the first frame.

According to an embodiment, the first object data may include data stored in a buffer having a size that is an integer multiple of audio samples per frame, and includes data storing data including the audio object data for the first frame, and the second object data may include data stored in a buffer having a size that is an integer multiple of audio samples per frame, and includes data storing, in frame order, data including audio object data for a second frame following the first frame and at least one frame preceding the second frame. The at least one frame preceding the second frame may include the first frame.

According to an embodiment, at least one processor, individually and/or collectively, may be configured to cause the electronic device to delay and output the input video frame for the first frame by a number of frames corresponding to a total number of delayed frames from when audio data regarding the first frame is input to when it is output.

According to an embodiment, at least one processor, individually and/or collectively, may be configured to cause the electronic device to: store the first frequency data in a first storage space of a first-in-first-out structure in the memory, and obtain the first frequency object data by applying the first mask data at the time when the first frequency data is output from the first storage space. The first storage space may include a storage space of a size requiring a time corresponding to the first frame delay from a time when the first frequency data is input to a time when the first frequency data is output. The first frequency data may include data stored in a buffer having a size that is an integer multiple of frequency components per frame, and may be data storing, in frame order, data including frequency components for the first frame and at least one frame preceding the first frame.

According to an embodiment, at least one processor, individually and/or collectively, may be configured to cause the electronic device to obtain first object data which is voice object data by separating a voice from first input data for the first frame of the input audio data including the voice and convert the first object data into corresponding text.

According to an embodiment, at least one processor, individually and/or

collectively, may be configured to cause the electronic device to: convert the first object data obtained by separating the voice into text in a first language, convert the text in the first language into text in a second language through machine translation, generate voice object data in the second language from the text in the second language using a text-to-speech (TTS) model, and reduce the sound volume of the first object data and add the voice object data in the second language in the first input data.

According to an embodiment, at least one processor, individually and/or collectively, may be configured to cause the electronic device to: obtain the first object data by separating a voice object from the first input data including a voice and adjust or remove the sound volume of the first object data in the first input data. Further, at least one processor, individually and/or collectively, may be configured to cause the electronic device to adjust or remove a sound volume of the remaining portion except for the first object data in the first input data.

According to an embodiment, at least one processor, individually and/or collectively, may be configured to cause the electronic device to separate, per object, the audio data of the plurality of objects from the input data including data in which the audio data of a plurality of objects are combined.

According to an embodiment, at least one processor, individually and/or collectively, may be configured to cause the electronic device to: simulate a spatial audio by transferring different outputs for the first object data to a plurality of spatially separated audio output units, respectively, considering location information of an audio object. At least one processor, individually and/or collectively, may be configured to cause the electronic device to simulate a spatial audio by recognizing a location and head direction of a user and generating, using a head-related transfer function (HRTF) in the audio object data, output audio data considering the location information of the audio object and the location and head direction of the user.

According to an embodiment of the disclosure, a method for operating an electronic device may be provided. The method of operating the electronic device may comprise: receiving audio data from an outside, converting the received audio data into a frequency domain, obtaining mask data for audio object separation using frequency domain data, applying a delay to the frequency domain data, performing audio object separation by applying mask data corresponding to the delay-applied frequency domain data, inversely converting the frequency domain audio object data into a time domain, and causing a plurality of audio object data for the same audio frame to overlap each other.

According to an embodiment, the method of operating the electronic device may comprise performing an overlap between an audio object data portion for the first frame included in the first object data and an audio object data portion for the first frame included in second object data. The second object data may be object data obtained before the first object data and include audio object data for the first frame.

According to an embodiment, the method of operating the electronic device may comprise at least one of storing first frequency data in a first storage space and obtaining first frequency object data by applying first mask data at a time when the first frequency data is output from the first storage space.

According to an embodiment, the method of operating the electronic device may comprise at least one of receiving video data for the first frame and delaying and outputting the input video data for the first frame by a second frame delay.

According to an embodiment, the method of operating the electronic device may comprise at least one of generating text in a first language corresponding to the first object data, generating text in a second language through machine translation from the text in the first language, generating voice object data in the second language using a TTS model from the text in the second language, and reducing the sound volume of the first object data and adding the voice object data in the second language in the first input data.

According to an embodiment, the method of operating the electronic device may comprise adjusting or removing the sound volume of the first object data in the first input data.

The ‘audio object’ or ‘sound object’ described in the disclosure may refer, for example, to an individual audio element that is a component of a specific sound or audio signal and may be separated into a single independent sound source unit. Further, the ‘audio object’ or ‘sound object’ may also be referred to as an ‘audio source’.

### BRIEF DESCRIPTION OF THE DRAWINGS

The same or similar reference denotations may be used to refer to the same or similar elements throughout the disclosure, including the drawings. The above and other aspects, features and advantages of certain embodiments of the present disclosure will be more apparent from the following detailed description, taken in conjunction with the accompanying drawings, in which:

FIG. 1 is a block diagram illustrating an example configuration of an electronic device according to various embodiments;

FIGS. 2A and 2B are diagrams illustrating an example operation in which an electronic device performs audio object separation according to various embodiments;

FIG. 3 is a diagram illustrating utilization of a buffer storing input audio data in an electronic device according to various embodiments;

FIG. 4 is a diagram illustrating an example method of applying a delay in a data processing process by an electronic device, according to various embodiments;

FIGS. 5A and 5B are diagrams illustrating an example method of applying overlap in a data processing process by an electronic device according to various embodiments;

FIGS. 6A and 6B are flowcharts illustrating an example operation of an electronic device according to various embodiments;

FIG. 7 is a diagram illustrating an example operation of applying a delay to input audio and video data by an electronic device, according to various embodiments;

FIGS. 8A, 8B, 8C, 8D and 8E are diagrams illustrating examples in which an electronic device separates and uses a voice object according to various embodiments;

FIG. 9 is a diagram illustrating an example operation of separating various audio objects for each object, according to various embodiments; and

FIGS. 10A, 10B and 10C are diagrams illustrating an example operation in which an electronic device simulates spatial audio, according to various embodiments.

### DETAILED DESCRIPTION

Hereinafter, various example embodiments of the disclosure are described in greater detail with reference to the drawings. However, the disclosure may be implemented in many different forms and is not limited to the various example embodiments described herein, but should be understood to include various modifications, equivalents, or alternatives of the various embodiments. The disclosure may be modified in various ways by one of ordinary skill in the art without departing from the scope of the disclosure, including the claims, and such modifications should be understood as being within the technical spirit and scope of the disclosure.

Hereinafter, in the disclosure, functions and configurations, technical terms and technical details that are well known in the technical field to which the disclosure belongs may be omitted. This is to convey the core issues of the disclosure more clearly and concisely by minimizing/reducing unnecessary details.

In the drawings, each block of the flowchart drawings and combinations of flowchart drawings may be performed by at least one instruction. The instructions may be installed in a processor of a computer or other programmable data processing equipment to produce means for performing the functions described in the drawings. The instructions may provide steps for performing the functions described in the drawings by being executed on a computer or other programmable data processing equipment.

Various elements and areas in the drawings are schematically drawn, and the technical spirit of the disclosure is not limited by the relative sizes, spacing, or arrangements drawn in the attached drawings. The electronic device of the disclosure is not limited to the configuration and/or operation in the drawings, and may include all other configurations capable of performing the same or similar functions.

The individual components depicted in the drawings are not necessarily physically distinct, but are separated to aid in the description and understanding of the disclosure. The disclosure may include configurations in which individual components illustrated in the drawings are merged, modified, or some components are deleted and/or added. Likewise, the operations depicted in the drawings are illustrative to aid description and understanding, and the disclosure may be modified by merging or changing the order of the operations depicted in the drawings, or deleting and/or adding some of the operations. For example, two or more operations depicted sequentially in a drawing may be performed substantially simultaneously or, if necessary, in reverse order.

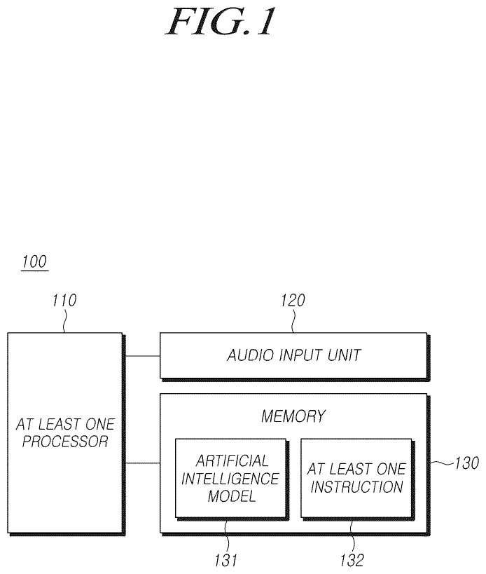

FIG. 1 is a block diagram illustrating an example configuration of an electronic device according to various embodiments.

The electronic device 100 of FIG. 1 may be, but is not limited to, a smartphone, a tablet PC, a PC, a smart TV, a mobile phone, a personal digital assistant (PDA), a laptop computer, a media player, a micro server, a digital broadcast terminal, a navigation, a kiosk, a home appliance, or other mobile or non-mobile computing devices. Further, the electronic device 100 may perform various computing functions, such as real-time video viewing and communication. The various example embodiments of the disclosure for the electronic device 100 below may be equally applied to other electronic devices having audio processing capabilities.

According to an embodiment, the electronic device 100 may include at least one processor (e.g., including processing circuitry) 110, an audio input unit (e.g., including audio input circuitry) 120, and memory 130.

According to an embodiment, the memory 130 includes a storage medium used by the electronic device 100 and may store data, such as at least one command 132 or configuration information corresponding to at least one program. The program may include an operating system (OS) program and various application programs. At least one instruction 132 stored in the memory 130 may, when executed by the at least one processor 110, cause the electronic device 100 to perform at least one operation.

According to an embodiment, the memory 130 may include at least one type of storage medium of flash memory types, hard disk types, multimedia card micro types, card types of memories (e.g., SD or XD memory cards), random access memories (RAMs), static random-access memories (SRAMs), read-only memories (ROMs), electrically erasable programmable read-only memories (EEPROMs), programmable read-only memories (PROMs), magnetic memories, magnetic disks, and optical discs.

According to an embodiment, the memory 130 may store an artificial intelligence model 131. The artificial intelligence model 131 may include, e.g., a computing system of several layers, and each layer may include a neural network model including several neurons or nodes that are basic units. The artificial intelligence model 131 may include data that may be used to learn a specific pattern or characteristic from input data and analyze or process new data based on the specific pattern or characteristic. The artificial intelligence model 131 may be, e.g., a neural network model generally including an input layer, a hidden layer, and an output layer, and may hierarchically process input data to convert the input data into an output. In this case, each neuron may be used to perform a calculation through weight, bias, and/or an activation function for an input value, and may be used to transfer the calculation result to the next layer. Through this structure, the artificial intelligence model 131 may be used to learn the relationship between input data.

According to an embodiment, the artificial intelligence model 131 may include an object separation network aimed at separating specific object signals to be separated by receiving an audio signal having several objects mixed as input. The object separation network may be used to learn a weight in a direction that minimizes/reduces a signal separated from a designated target signal.

According to an embodiment, a buffer may be statically and/or dynamically allocated to the memory 130. The buffer may include a storage space for temporarily storing data, and there may be a specific relationship between the order in which data is input and the order in which data is output. For example, it may have a first-in-first-out (FIFO) structure or a last-in-first-out structure, but the disclosure is not limited thereto.

According to an embodiment, data at each step of the audio object separation process may be stored in the buffer in units of audio samples. For example, the buffer may store, per audio sample, at least one data among input audio data, data obtained by converting the input audio data into a frequency domain, frequency domain data in which object separation has been performed, or data obtained by inversely converting the object-separated frequency domain data into a time domain.

In an embodiment, data for the same audio sample may be duplicated as needed and stored separately in a plurality of different buffers in the memory 130. The different buffers may refer, for example, to buffers allocated at different positions in the storage space included in the memory 130.

According to an embodiment, the audio input unit 120 may include various circuitry and receive audio data through a tuner, an input/output unit (e.g., including circuitry), and/or a communication unit (e.g., including communication circuitry). The audio input unit 120 may include at least one of the tuner and the input/output unit. The tuner may tune and select the frequency of the broadcast channel to be received by the electronic device 100 among many radio components, by amplifying, mixing, and resonating the broadcast signals wiredly/wirelessly received. The broadcast signal may include audio and additional data. The input/output unit may include at least one of an audio jack, an audio input port, and a USB input port capable of receiving audio data from an external device. The communication unit may include various communication circuitry and transmit/receive audio data from an external server and/or other electronic devices through a wired and/or wireless network. The communication unit may include a function of streaming or downloading audio data in real-time.

According to an embodiment, the audio input unit 120 may receive an analog audio signal from the outside and sample the analog audio signal. The sampling may refer, for example, to measuring analog signals at regular time intervals. In this case, the number of times an analog signal is measured per second is called a sampling rate, and for example, a sampling rate of 48 kHz may refer, for example, to measuring an analog signal at regular time intervals of about 20.83 μs (microsecond). The audio input unit 120 may quantize the sampled data to convert the same into a discrete value according to a predetermined (e.g., specified) bit depth, convert the same into a digital code, and finally obtain digital audio data.

According to an embodiment, the audio input unit 120 may directly receive digital audio data from the outside. In this case, the audio input unit 120 resamples the input digital data to change the existing sampling rate. For example, the audio input unit 120 may receive 48 KHz audio data and convert it to 44.1 kHz, or conversely, convert 44.1 kHz data to 48 KHz.

According to an embodiment, the at least one processor 110 may include various processing circuitry and execute control, calculation, and/or data processing of at least part of the electronic device 100 by executing at least one instruction 132 stored in the memory 130.

According to an embodiment, the at least one processor 110 may include at least one processing circuit and/or multiple processors. One or more of the at least one processor 110 may be configured to individually and/or collectively perform various functions described in the disclosure. In the disclosure, when it is described that “processor”, “at least one processor”, or “one or more processors” are configured to perform various functions, these terms may cover, e.g., a situation in which one processor performs some of the cited functions and another processor(s) performs other some of the cited functions, and may also cover a situation in which a single processor may perform all of the cited functions, but embodiments of the disclosure are not limited thereto. Additionally, the at least one processor 110 may include, e.g., a combination of processors performing various functions cited/initiated in a distributed manner. The at least one processor 110 may execute program instructions to achieve or perform various functions.

According to an embodiment, the at least one processor 110 may include at least one of a central processing unit (CPU), a graphic processing unit (GPU), a neural network processing unit (NPU), a micro controller unit (MCU), a sensor hub, a supplementary processor, a communication processor, an application processor, an application specific integrated circuit (ASIC), or field programmable gate arrays (FPGA) and may have multiple cores.

According to an embodiment, at least one processor 110 may include an audio DSP and an NPU. The audio DSP is a microprocessor specialized in digital processing of audio signals, and may effectively process operations such as filtering or fast Fourier transform (FFT) that require high-speed computation. The NPU may include a processor specialized in neural network computation, and may be, e.g., a processor optimized for processing parallel operations of machine learning and/or deep learning models.

According to an embodiment, the at least one processor 110 may convert a time domain input audio signal into a frequency domain. In this case, the separated object signal may be inversely converted back into the original time domain.

According to an embodiment, the conversion may be performed using various mathematical conversion operations. For example, the conversion may be performed using discrete Fourier transform (DFT), short-time Fourier transform (STFT), and/or fast Fourier transform (FFT). According to an embodiment, the inverse conversion may be performed through the reverse operation of the conversion, e.g., inverse discrete Fourier transform (IDFT), inverse short-time Fourier transform (ISTFT), and/or inverse fast Fourier transform (IFFT), but the disclosure is not limited thereto.

According to an embodiment, the at least one processor 110 may perform pre-processing for performing an operation, e.g., filtering or normalization, on the data obtained by converting the input signal into the frequency domain. The at least one processor 110 may generate, from the pre-processed data, mask data for audio object separation using the artificial intelligence model 131 and/or the object separation network included in the artificial intelligence model 131.

According to an embodiment, the mask data may be data that serves as a filter used to emphasize a specific object or suppress other objects in the audio object separation operation. The mask data may be one of a binary mask indicating whether the corresponding signal component corresponds to the target signal as 0 and 1, or a soft mask indicating a degree corresponding to the target signal as a continuous value between 0 and 1. The mask data may be, e.g., data in the form of a numerical vector applied by multiplying frequency domain audio data.

According to an embodiment, the at least one processor 110 may analyze characteristics of various objects from various given sample audio signals using the artificial intelligence model 131, distinguish object data included in each sample audio signal, learn the relationship, and optimize and/or enhance the artificial intelligence model 131.

According to an embodiment, in the training process, the at least one processor 110 may add an audio signal and object information corresponding thereto, as training data, to the artificial intelligence model 131, analyze patterns for frequency, time, and sound characteristics of each sample audio, and optimize the weight and bias of the artificial intelligence model 131. The artificial intelligence model 131 may be enhanced to identify or separate pre-learned objects in new input audio signals due to the training process. The separation may refer, for example, to extracting each object as each independent signal to be used individually in subsequent processing.

According to an embodiment, the at least one processor 110 may perform audio object separation by applying the mask data to frequency domain audio data. In this case, the at least one processor 110 may apply the mask data at a time after a designated frames by applying as long a delay as the designated frames, rather than immediately applying the mask data to the frequency domain audio data for a specific frame.

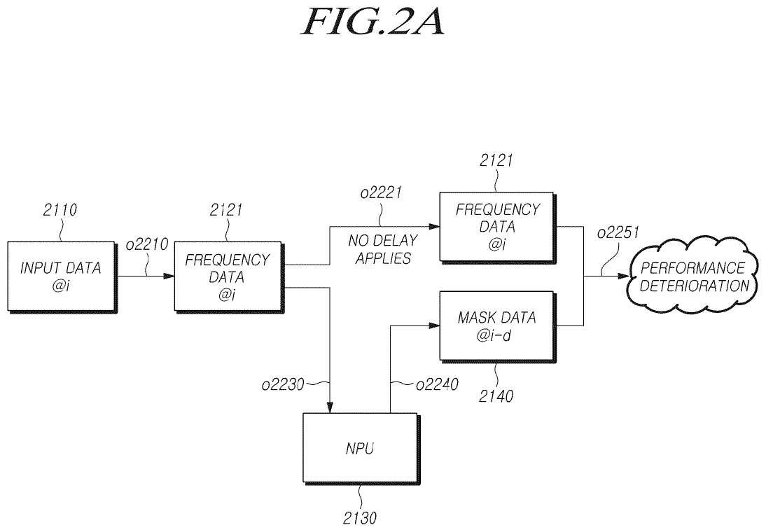

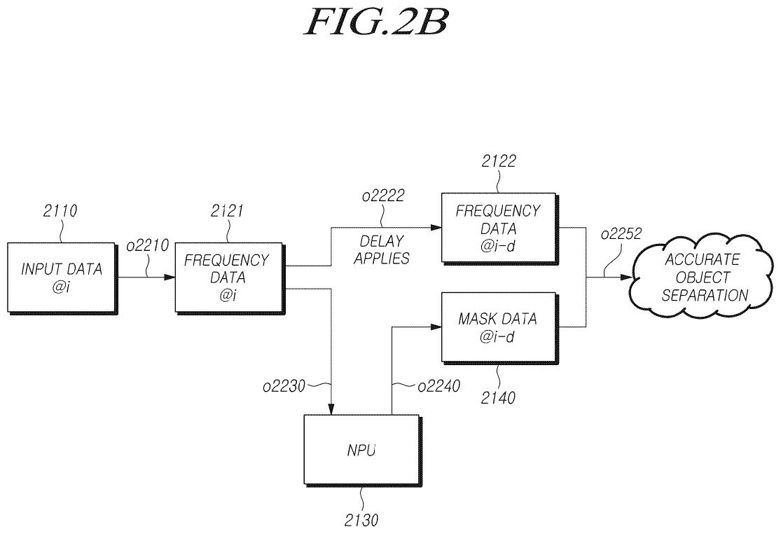

FIGS. 2A and 2B are diagrams illustrating an example operation according to whether an electronic device (e.g., the electronic device 100 of FIG. 1) applies a delay according to various embodiments.

In the following, for the sake of simplicity of the description, some expressions are represented as follows:

“Input data” refers to audio data received from the audio input unit (e.g., the audio input unit 120 of FIG. 1) and transferred to the subsequent module, and refers to a signal obtained by converting an external analog signal into a digital signal and/or a signal obtained by resampling the external digital signal. When the input data is stored in the buffer in the memory 130, the corresponding buffer is referred to as an “input buffer.”

“Frequency data” refers to data obtained by converting the input data into the frequency domain. When the frequency data is stored in the buffer in the memory 130, the corresponding buffer is referred to as a “frequency buffer.”

“Frequency object data” refers to frequency domain data obtained by performing object separation with the mask data applied to the frequency data.

“Object data” refers to data obtained by inversely converting the frequency object data into the time domain. When the object data is stored in the buffer in the memory 130, the corresponding buffer is referred to as an “object buffer.”

Hereinafter, for the sake of brevity in the description, the terms defined above are denoted by appending the frame number to indicate that they correspond to a specific audio frame. For example, @k is added therebehind to indicate that it corresponds to the kth frame. For example, frequency data @k denotes frequency data corresponding to the kth frame. When data for a plurality of frames is stored in the buffer, the corresponding buffer is marked with the number of the last frame among the plurality of frames. For example, if data for the kth, (k−1)th, and (k−2)th frames are stored in the frequency buffer, the frequency buffer is denoted as frequency buffer@k.

The NPU 2140 illustrated in FIGS. 2A and 2B is an example of a processing unit that may be included in at least one processor (e.g., the at least one processor 110 of FIG. 1), but the disclosure is not limited thereto. The NPU 2140 may be redisposed with at least one other processing unit capable of generating mask data for audio object separation using an artificial intelligence model (e.g., the artificial intelligence model 131 of FIG. 1).

Referring to FIG. 2A, the electronic device 100 according to an embodiment of the disclosure may perform at least one of the following example operations:
The operation of converting input data @i 2110 to obtain frequency data @i 2121 for the ith frame (o2210),
The operation of pre-processing the frequency data @i 2121 and transferring the same to the NPU 2130 (o2230),
The operation in which the NPU 2130 generates mask data using the object separation network included in the artificial intelligence model 131 and transfers the same to the subsequent module (o2240), and
The operation of applying the mask data @i−d 2140 to perform corresponding object separation immediately, without delay-processing the frequency data @i 2121 (o2251).

In this case, d is the number of frames corresponding to the processing time (e.g., the total required time of operation o2230 and operation o2240) until mask data is obtained from frequency data. If the mask data is immediately applied to the frequency data @i 2121, the mask data @i−d 2140 may be applied. The reason why the frequency data @i (2121) does not match the mask data @i is that it requires a processing time, such as an operation time and a time to input data to the memory 130 or read stored data, to obtain mask data from frequency data. For the same reason, the mask data @i generated from the frequency data @i 2121 may then be matched with the frequency data @i+d. Accordingly, matching for the same frame is not performed, and thus the audio object separation performance may be deteriorated.

According to an embodiment, the processing time (e.g., the total required time of operation o2230 and operation o2240) until the mask data is obtained from the frequency data is not always constant but may vary according to various factors such as the load state of the related processor (e.g., NPU 2130) and the complexity of frequency data. Accordingly, in order to set an appropriate frame delay to optimize the audio object separation performance, the frame delay d may be set using a statistical representative value after obtaining statistics of the processing time for numerous samples. The frame delay d may correspond to the number of frames by which the frequency data is to be delayed, or to the frame-based offset for delaying the frequency data.

According to an embodiment, the statistical representative value for setting the frame delay d may be a value obtained by at least one of the following example methods:
(i) A value obtained by averaging the processing times and then converting the same into frames or an average of the values obtained by converting the processing times into frames. The processing time is a continuous value, and the number of frames is a natural number; therefore, here and hereinafter, the term ‘value converted into frames’ may refer to ‘a value obtained by dividing by the time per frame and rounding, rounding up, or rounding down to the first decimal place.’
(ii) A value obtained by converting the median value of the processing times into frames, or a median value of the values obtained by converting the processing times into frames.
(iii) The mode of the values obtained by converting the processing times into frames.
(iv) A representative values obtained by any of the methods (i) to (iii) after excluding some higher values among the processing times. For example, a representative value obtained by any one of the methods (i) to (iii) for 95 percentile of the processing times and values below.

According to an embodiment, the frame delay d may be a predesignated number of frames by any one of the methods (i) to (iv) above. According to an embodiment, the frame delay d may be updated based on additional statistics even after it is initially set.

Referring to FIG. 2B, the electronic device 100 according to an embodiment of the disclosure may perform at least one of the following example operations:
The operation of converting input data @i 2110 to obtain frequency data @i 2121 for the ith frame (o2210),
The operation of pre-processing the frequency data @i 2121 and transferring the same to the NPU 2130 (o2230),
The operation in which the NPU 2130 generates mask data for audio object separation using the object separation network included in the artificial intelligence model 131 and transfers it to the subsequent module (o2240),
The operation o2222 of applying as long a delay as d frames to the frequency data (o2222), and
The operation of performing corresponding object separation by applying the mask data @i−d 2140 to the frequency data @i−d 2122 to which as long a delay as d frames is applied from the time before the d frames (o2252).

In other words, in FIG. 2B, the mask data of the same frame may be applied to frequency data to perform object separation (2252). Accordingly, audio object separation may be performed more accurately.

Table 1 below illustrates, for an embodiment of the disclosure, the k value when frequency data@i 2121 and mask data@i−k (e.g., mask data@i−d 2140) are matched, e.g., the object separation performance according to the difference in the number of frames between the frequency data and mask data, as an indicator of the signal-to-distortion ratio (SDR). SDR is an indicator for measuring distortion between the separated audio signal and the original signal, where a higher SDR value signifies superior audio object separation performance.

TABLE 1

| k | Signal-to-Distortion Ratio (dB) |
|---|---|
| 0 (exact match) | 5.83 |
| 1 | 5.7 |
| 2 | 5.38 |
| 3 | 4.89 |
| 4 | 4.42 |
| 5 | 4.02 |

According to an embodiment related to Table 1, as shown in FIG. 2A, when no delay is applied, d=2, that is, referring to row k=2 of Table 1, an SDR of 5.38 dB may be obtained. When accurate matching (k−0) was performed by applying a delay of 2 frames as illustrated in FIG. 2B, an SDR of 5.83 dB could be obtained by referring to Table 1. In other words, it was identified that the audio object separation performance was enhanced by applying a delay of d frames.

According to an embodiment, the operations illustrated in FIGS. 2A and 2B may be performed by at least one processor 110 executing at least one instruction 132 stored in the memory 130.

According to an embodiment, among the operations illustrated in FIGS. 2A and 2B, the operation o2210 of converting input data into frequency data, the operation o2230 of pre-processing and transferring the same to the NPU, and/or the operation o2252 and/or o2251 of performing object separation with the mask data applied to the frequency data to which a delay is applied (o2222) or is not applied (o2221), may be performed by a separate process other than the NPU 2130. For example, they may be performed by the audio DSP.

According to an embodiment, the operation o2230 of pre-processing the frequency data and sending the same to the NPU 2130 and/or the operation o2240 of receiving the mask data by the separate processor may be performed in such a manner that the two processors directly exchange data or in a manner to exchange data through shared memory, rather than exchanging data directly. According to an embodiment, the shared memory may be a random-access memory (RAM).

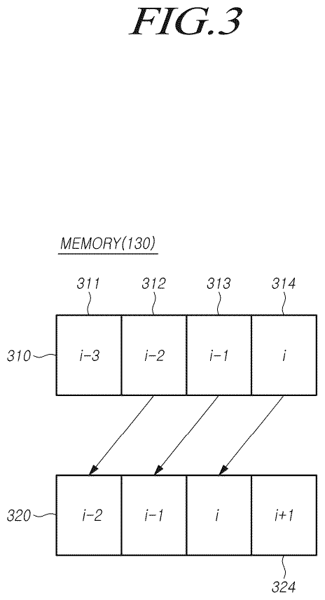

FIG. 3 is a diagram illustrating an example in which an electronic device (e.g., the electronic device 100 of FIG. 1) stores, per frame, input data in the input buffer in the memory 130 according to various embodiments. FIG. 3 illustrates an example in which the size of the input buffer is four times the number of audio samples per frame for convenience of understanding.

According to an embodiment, as described above, the electronic device 100 may use a mathematical conversion operation to convert input data into the frequency domain. In this case, the frequency interval is inversely proportional to the number of audio samples to be converted. Thus, as the number of audio samples increases, the frequency resolution may increase, enabling precise frequency component analysis. Therefore, if the data of a plurality of frames is stored in the input buffer and then the data in the input buffer is converted, rather than performing conversion per frame, more audio samples may be converted, enabling more accurate frequency component analysis.

According to an embodiment, the number of audio samples that may be stored in the input buffer may be an integer multiple of the number of audio samples per frame. In other words, if the number of audio samples per frame is F and the number of audio samples that may be stored in the input buffer is B, B=nF for the natural number n. For example, as illustrated in FIGS. 3, n=4 and B=4F may be used.

According to an embodiment, referring to FIG. 3, when n=4, at the time when the input data @i 314 is stored in the input buffer@i 310, the input data 311, 312, 313 and 314 of the i−3th, i−2th, i−1th, and ith frames may be stored in order in the input buffer@i 310. The input buffer@i 310 may have a first-in-first-out structure, e.g., after one frame, the oldest input data @i−3 311 is deleted, the input data of the remaining three frames may be moved forward, and new input data @i+1 324 may be added to the last empty portion. As a result, it may be the input buffer@i+1 320.

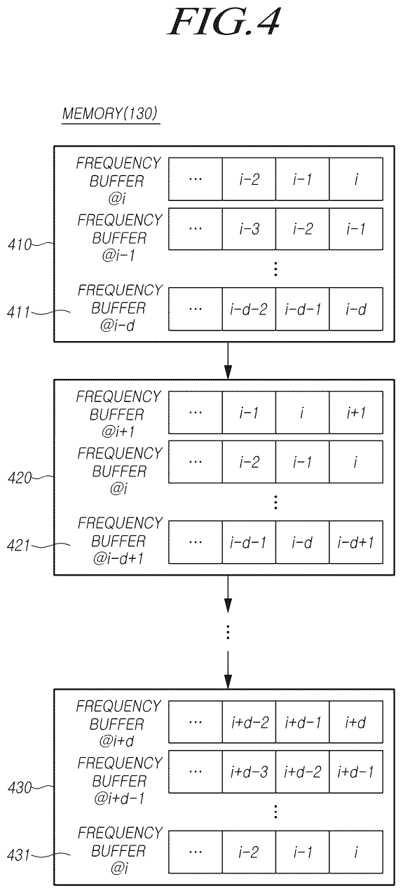

FIG. 4 is a diagram illustrating a state in which an electronic device (e.g., the electronic device 100 of FIG. 1) stores a plurality of frequency buffers that store frequency data for each frame in the memory 130 at each time according to various embodiments.

According to an embodiment, referring to FIG. 4, d+1 frequency buffers having the same size for consecutive frames may be simultaneously stored in the memory 130. d may be the number of frames corresponding to the processing time until mask data is obtained from the frequency data. Referring to FIG. 4, e.g., at frame@i time 410, a frequency buffer@i, a frequency buffer@i−d, and a frequency buffer of a frame between them may be stored in the memory 130. Each time a frame passes, one oldest frequency buffer may be deleted and one new frequency buffer may be added.

According to an embodiment, referring to FIG. 4, when the oldest frequency buffer (e.g., the frequency buffer@i 431 at the frame@i+d time) among the stored frequency buffers is matched with the mask data of the same time, the mask data for the same frame may be accurately matched. In other words, the delay application operation (e.g., operation o2222 of FIG. 2B) and the object separation operation through accurate matching (e.g., operation o2252 of FIG. 2B) may be performed by storing and using several frequency buffers as illustrated in FIG. 4. For example, at the frame@i time 410, the frequency buffer@i−d 411 and the mask data@i−d may be matched, at the frame@i+1 time 420, the frequency buffer@i−d+1 421 and the mask data@i−d+1 may be matched, and at the frame@i+d time 430, the frequency buffer@i 431 and the mask data@i may be matched.

According to an embodiment, the delay may be applied by storing and using more buffers than d+1 in a method similar to that of FIG. 4. For example, a delay may be applied by storing k frequency buffers for k>d+1 and reading and utilizing a portion (e.g., the frequency buffer@i−d portion at the frame@i time) of the frame required in the storage space.

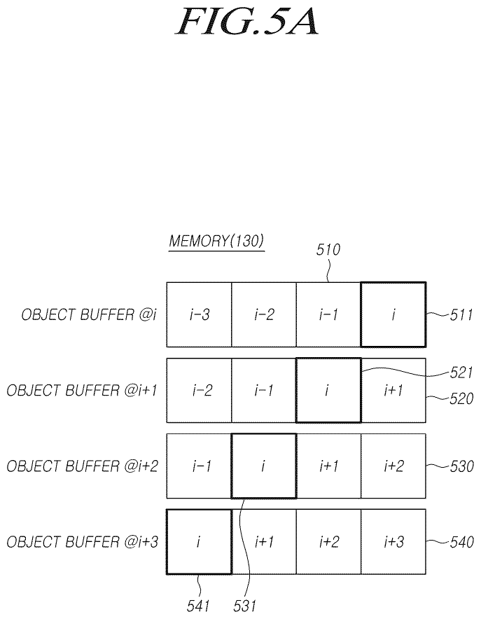

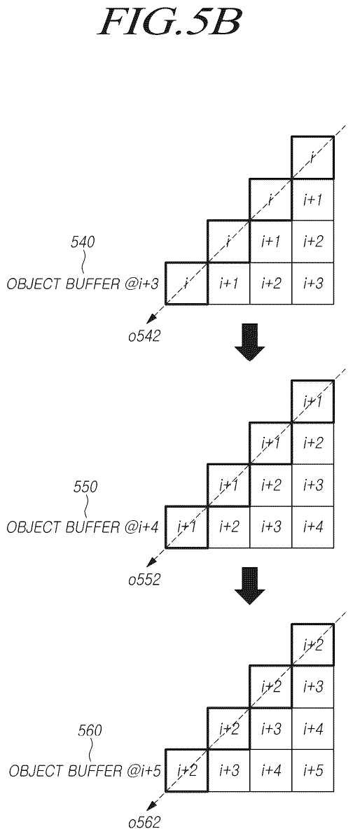

FIG. 5A is a diagram illustrating an example in which object data is stored for each frame in an object buffer in the memory 130 according to various embodiments. For convenience of understanding, FIG. 5A illustrates an example in which the size B of the object buffer is four times the number F of audio samples per frame, e.g., B=4F.

Referring to FIG. 5A, if each object buffer of size B is represented by a [1:B] section 511, the object data for the ith frame is stored in all of a [3F+1: B] section 511 of the object buffer@i 510, a [2F+1:3F] section 521 of the object buffer@i+1 520, a [F+1:2F] section 531 of the object buffer@i+2 530, and a [1:F] section 541 of the object buffer@i+3 540. According to an embodiment, it is possible to obtain the overlapping object data@i which is the stable audio object separation result for the ith frame by allowing the whole or part of the data to overlap.

FIG. 5B is a diagram illustrating example object data stored in memory 130 according to various embodiments. FIG. 5B illustrates an example in which the size B of the object buffer is four times the number F of audio samples per frame.

Referring to FIG. 5B, according to an embodiment, by deleting object data that has already been overlapped and output, only object data for the frames to perform the overlap and the frames to follow may be left in the memory 130. For example, at the time (the view at the top of FIG. 5B) to overlap the object data for the frame i+3, the data in which the object data for the frame@i−1 has been deleted in the object buffer@i+3 540 and the object buffer@i+2 530, the data in which the object data for the frame@i−1 and the frame@i−2 has been deleted in the object buffer@i+1 520, and the data in which the object data for the frame@i−3 to the frame@i−1 has been deleted in the object buffer@i 510 may be stored.

Referring to FIG. 5B, in operation o542, the electronic device (e.g., the electronic device 100 of FIG. 1) may overlap and output object data for the frame@i. As the object data for the frame i is output, the object data for the frame@i+1 to @i+3 may remain in the object buffer@i+3 540.

Referring to FIG. 5B, in operation o552, the electronic device 100 may overlap and output the object data for the frame@i+1. Accordingly, the object data for the frames@i+2 to the frame@i+4 may remain in the object buffer@i+4 550, and the object data for the frame@i+2 and the frame@i+3 may remain in the object buffer@i+3 540 according to operations o542 and o552.

Referring to FIG. 5B, in operation o562, the electronic device 100 may overlap and output the object data for the frame@i+2. Accordingly, the object data for the frame@i+3 to the frame@i+5 may remain in the object buffer@i+5 560, and the object data for the frame@i+3 and the frame@i+4 may remain in the object buffer@i+4 550 according to operations o552 and o562. According to operations o542, o552, and o562, only the object data for the frame@i+3 may remain in the object buffer@i+3 540.

According to an embodiment, when B=nF, up to n object data may be overlapped in the same manner as in FIG. 5A. In this case, the size of the total storage space occupied for overlapping is nB=n*nF=n²F, and thus the size of the total storage space occupied may be proportional to n².

According to an embodiment, when B=nF, up to n object data may be overlapped in the same manner as in FIG. 5B. In this case, the size of the total storage space occupied for overlapping is

$$\frac{( {n}^{2} + n ) F}{2} ,$$

and thus the size of the total storage space occupied may be proportional to n²+n. In this case, since

$${n}^{2} > \frac{{n}^{2} + n}{2}$$

for natural number n>1, the memory may be saved compared to performing overlapping in the method such as FIG. 5A when performing overlapping in the method such as FIG. 5B.

According to an embodiment, overlapping a plurality of different object data for the same frame may reduce the effect of noise by offsetting random noises compared to when only one object data is obtained. Accordingly, the sound of the desired object may be obtained more clearly.

According to an embodiment, overlapping a plurality of different object data for the same frame may compensate for inaccuracies in each mask data calculation algorithm, e.g., overshoot and/or undershoot due to over- or under-weighting applied to a specific frequency compared with when only one object data is obtained. In other words, different object data obtained as a result of applying different mask data may produce complementary results.

According to an embodiment, when a plurality of different object data obtained at different frame times for the same frame are overlapped, the degree of variation of mask data between adjacent frames may be reduced. Accordingly, the consistency of object separation between adjacent frames is increased, and audio interruption and/or unnatural switching problems between frames may be mitigated. For example, in the example of FIG. 5A, if object data for the frame@i+1 are overlapped, the corresponding portions are overlapped in the object buffer@i+1 520, object buffer@i+2 530, object buffer@i+3 540, and object buffer@i+4 550. When overlapping object data for the frame@i in the example of FIG. 5A, as described above, the corresponding portions are overlapped in the object buffer@i+1 520, object buffer@i+2 530, and object buffer@i+3 540. In other words, in the example of FIG. 5A, each of the overlapping object data is a result obtained by overlapping the results of applying four different mask data, and three of the four mask data may be identical for the overlapping object data@i and the overlapping object data@i+1. Accordingly, the variability between frames of object separation is decreased, and when transferred from the overlapping object data@i to the overlapping object data@i+1, a natural flow of object sound may be obtained.

According to an embodiment, referring to FIGS. 5A and 5B, in order to overlap object data, a delay of n−1 frames for n=B/F may further occur. For example, when n=4 as illustrated in FIG. 5, a delay of three frames may occur to overlap four data. If the delay is applied by the d frames as illustrated in FIG. 2B prior to the overlapping (2222), the final delay may be d+n−1 frames.

According to an embodiment, the overlapping may be performed by applying at least one window function in addition to a method of simply calculating an arithmetic average of each signal. The at least one window function is a function used to apply a weight to a specific section of a signal during signal processing, and may include at least one of, e.g., a hann window, a hamming window, and a rectangular window

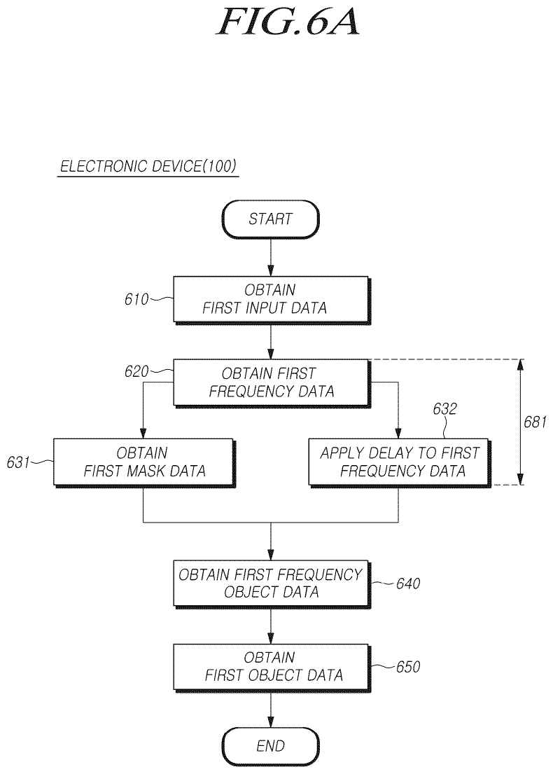

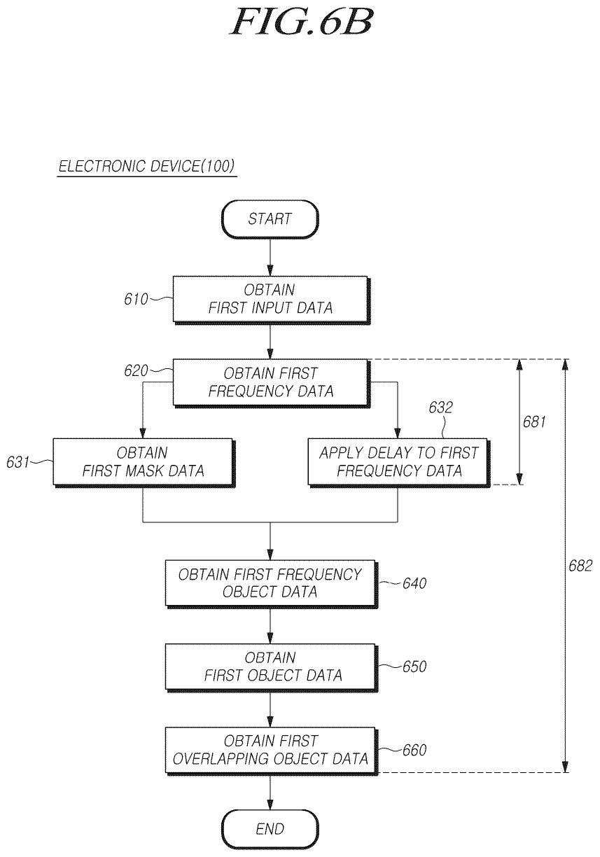

FIG. 6A is a flowchart illustrating an example process in which an electronic device 100 separates an audio object for a first frame and outputs object data according to various embodiments.

Referring to FIG. 6A, in operation 610, the electronic device 100 may obtain first input data for the first frame from the outside through an audio input unit (e.g., the audio input unit 120 of FIG. 1). According to an embodiment, the first input data may be stored in the input buffer.

Referring to FIG. 6A, in operation 620, the electronic device 100 may obtain first frequency data by converting the first input data into the frequency domain. According to an embodiment, the first frequency data may be stored in the frequency buffer.

Referring to FIG. 6A, in operation 631, the electronic device 100 may obtain first mask data from the first frequency data using the object separation network. According to an embodiment, operation 631 may be performed by pre-processing the first frequency data in the first processor (e.g., audio DSP) and sending the same to the second processor (e.g., NPU), and then calculating the first mask data using the object separation network in the second processor and then transferring the same back to the first processor.

Referring to FIG. 6A, in operation 632, the electronic device 100 may apply a first delay 681 to the first frequency data. The first delay 681 is a delay corresponding to the processing time until mask data is obtained from the frequency data, e.g., the time required of operation 631 in FIG. 6, and may be, e.g., a delay 2222 of d frames in FIG. 2B. A method of applying the first delay 681 may be, e.g., as described with reference to FIG. 4, but the disclosure is not limited thereto.

Referring to FIG. 6A, in operation 640, the electronic device 100 may obtain the first frequency object data by applying the first mask data to the delay-applied first frequency data and performing object separation.

Referring to FIG. 6A, in operation 650, the electronic device 100 may obtain first object data by, for example, inversely converting the first frequency object data into the time domain. The first object data may be stored in the object buffer.

According to an embodiment, the electronic device 100 may output the first object data. In this case, the time required for operations 610, 620, 640, and 650 may be negligible compared to the time per frame, and accordingly, the total time required from the input of audio data to the output of object data for the first frame may be equal to the first delay. The first delay may be, e.g., a delay of d frames as illustrated in FIG. 2B.

FIG. 6B is a flowchart illustrating an example operation in which an electronic device 100 obtains a plurality of different audio data for a first frame and then overlaps the plurality of audio data to obtain overlapping object data according to various embodiments.

Referring to FIG. 6B, in operation 660, the electronic device 100 may obtain first overlapping object data by overlapping a plurality of object data for the first frame as well as the first object data. A method of performing overlapping may be, e.g., as described with reference to FIGS. 5A and/or 5B, but is not limited thereto. An additional delay may occur due to overlapping, and the additional delay may be, e.g., n−1 frames as described with reference to FIGS. 5A and 5B.

According to an embodiment, the electronic device 100 may output first overlapping object data. In this case, the time required for operation 610, operation 620, operation 640, and operation 650 may be negligible compared to the time per frame, and accordingly, the total time required from the input of audio data to the output of overlapping object data for the first frame may be equal to the sum of the first delay and the required time of operation 660, e.g., the second delay. The second delay may be, e.g., a delay of d+n−1 frames as illustrated in FIGS. 2B, 5A, and 5B.

The operations described with reference to FIG. 6A and FIG. 6B may be performed by executing at least one instruction (e.g., at least one instruction 132 of FIG. 1) by at least one processor (e.g., the at least one processor 110 of FIG. 1).

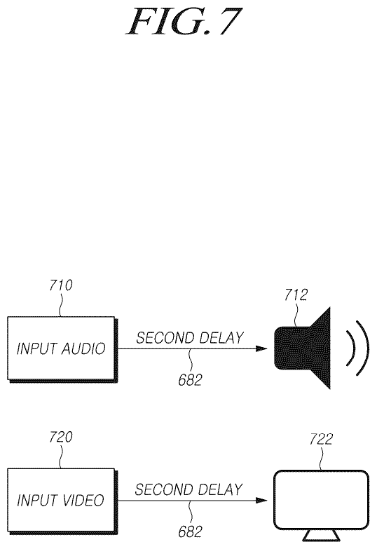

FIG. 7 is a diagram illustrating an example in which audio data and video data are input and output in an electronic device (e.g., the electronic device 100 of FIG. 1) according to various embodiments.

As described above in FIGS. 6A and 6B, according to an embodiment, the total delay from the time 710 when audio data is input to the electronic device 100 to the time 712 when audio data is output may be equal to the second delay 682.

Referring to FIG. 7, according to an embodiment, the electronic device 100 may output a video by applying the second delay 682 from the time 720 when video data is input to synchronize video and audio (722).

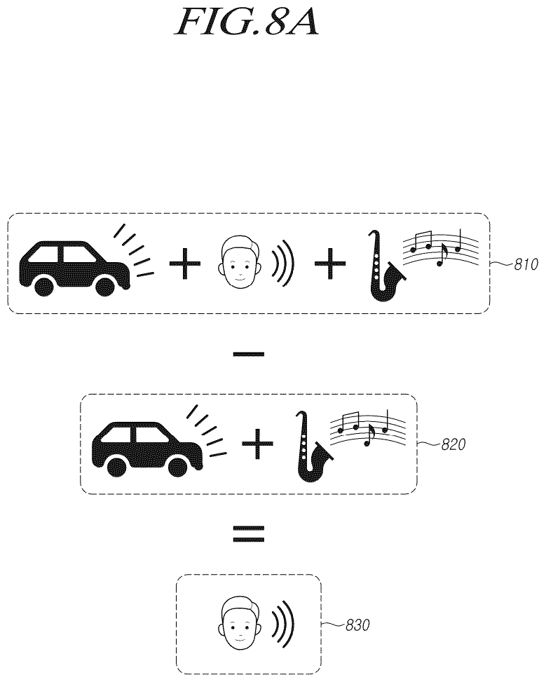

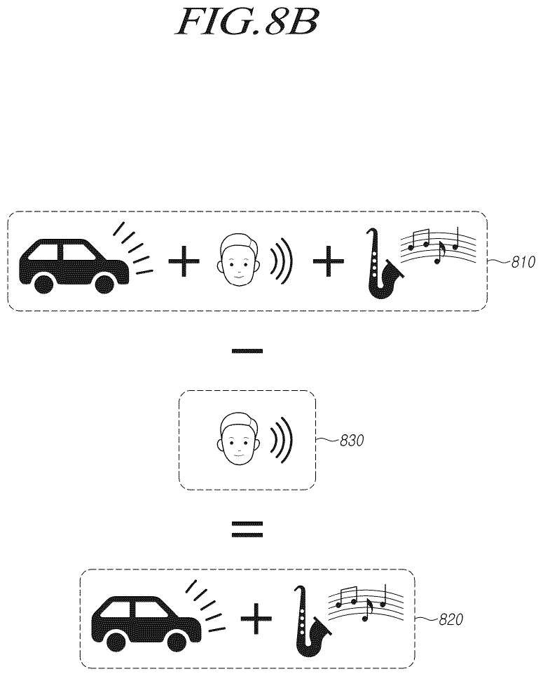

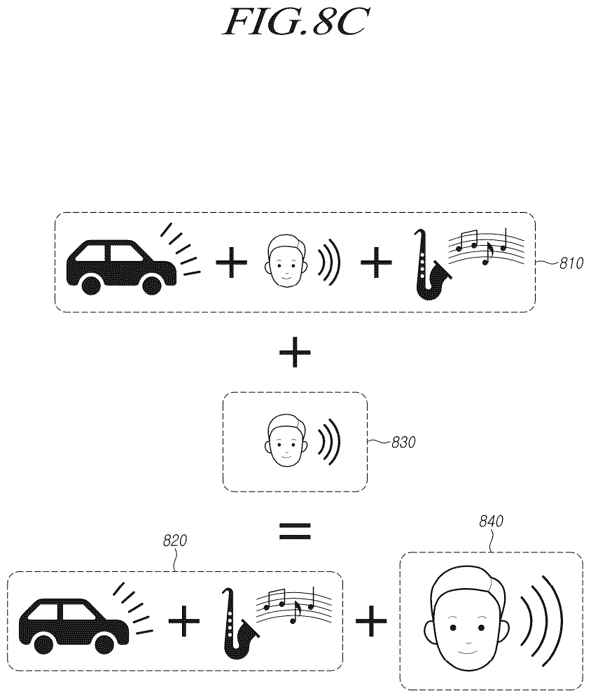

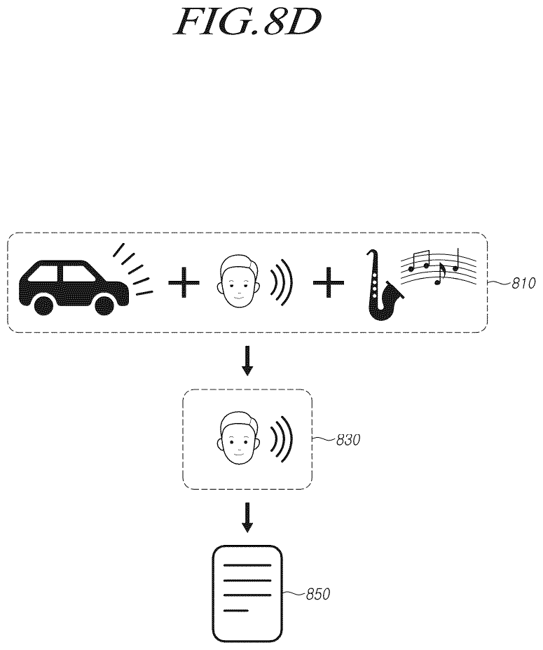

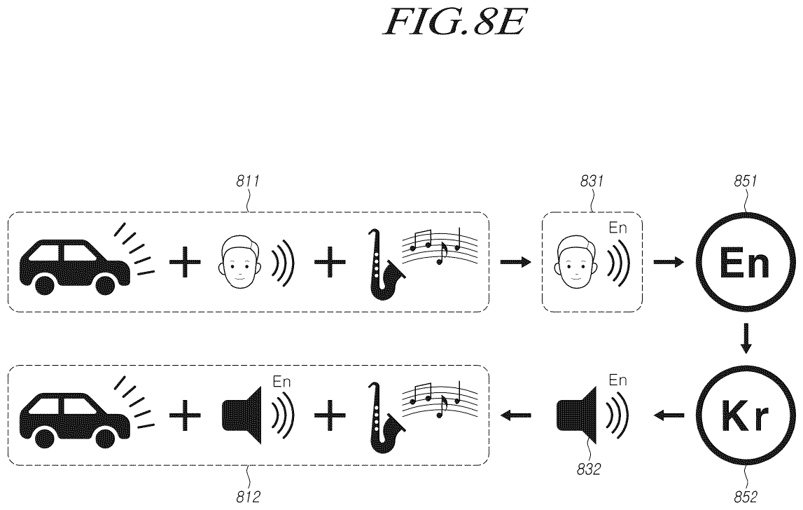

FIGS. 8A, 8B, 8C, 8D and 8E are diagrams illustrating various examples in which an electronic device (e.g., the electronic device 100 of FIG. 1) performs and utilizes object separation from an audio including voice according to various embodiments.

According to an embodiment, in FIGS. 8A, 8B, 8C, 8D and 8E (which may be referred to as FIGS. 8A to 8E), the electronic device 100 may receive a sound 810 including voice, and, e.g., as described with reference to FIG. 2B, apply a delay to the frequency data and then apply mask data to perform more accurate audio object separation.

According to an embodiment, in FIGS. 8A to 8E, the electronic device 100 may receive the sound 810 including voice and, e.g., as described with reference to FIG. 5A or 5B, obtain the plurality of different audio object data for the same frame and overlap them to obtain a more stable audio object separation result.

Referring to FIG. 8A, according to an embodiment, the electronic device 100 may receive the sound 810 including voice and separately separate only the voice object 830. According to an embodiment, the electronic device 100 may enhance the sound quality of a video call, a voice over internet protocol (VOIP) call, and/or a hearing aid device by removing the sound 820 other than the voice and outputting only the voice object 830.

Referring to FIG. 8B, according to an embodiment, the electronic device 100 may output only the sound 820 other than voice from the input audio after separating the voice object 830 from the sound 810 including voice. For example, when the input audio is a song sound in which voice and MR (music recorded) are mixed, only the MR may be output.

Referring to FIG. 8C, according to an embodiment, the electronic device 100 may separate the voice object 830 from the sound 810 including voice, and then add the voice object 830 to the sound 810 including voice and output the result. Accordingly, an audio including voice 840 amplified compared to the input audio may be output. Similarly, according to an embodiment, it may be possible to increase or decrease only the volume of the voice in the input audio by adding or subtracting data in which the volume of the voice object 830 has been adjusted in the sound 810 including voice.

Referring to FIG. 8D, according to an embodiment, the electronic device 100 may separate the voice object 830 from the sound 810 including voice and then apply a speech-to-text (STT) model to the voice object to generate corresponding text 850.

According to an embodiment, the STT model may include an acoustic model and/or a language model. The acoustic model may be a model for receiving a voice signal and converting the voice signal into phoneme units. The language model may be a sentence that generates a word or a sentence by combining the phonemes.

According to an embodiment, the STT model may include a model using natural language processing (NLP). The NLP may be used to generate sentences that fit the context and are natural based on the grammatical structure or linguistic rules of the sentence. For example, it may be utilized for homonym processing, context understanding, and/or application of correct grammar.

Referring to FIG. 8E, according to an embodiment, the electronic device 100 may receive a sound 811 including a voice in a first language, separate a voice object 831 in the first language, apply a speech-to-text (STT) model to the voice object 831 in the first language to generate text 851 in the first language, obtain text 852 in a second language from the text 851 in the first language using machine translation, apply a text-to-speech (TTS) model to the text 852 in the second language to generate a voice object 832 in the second language, remove the original voice object 831 from the input sound 811 and add the voice object 832 in the second language to obtain a sound 812 including the voice in the second language. Resultantly, audio where only the voice has been translated while the background sound is maintained as it is in the input audio may be output.

According to an embodiment, the TTS model is a model for converting text data into a voice signal, and may be a model based on an artificial intelligence model (e.g., the artificial intelligence model 131 of FIG. 1). The electronic device 100 may learn the acoustic characteristics of the voice signal sample using the artificial intelligence model 131-based TTS model, and convert the text into a natural voice by reflecting the learned accent, pronunciation, rhythm, or the like.

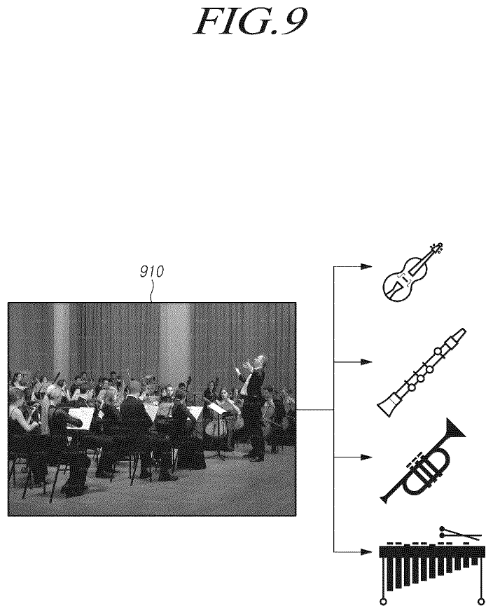

FIG. 9 is a diagram illustrating an example in which an electronic device (e.g., the electronic device 100 of FIG. 1) receives audio data 910 where a plurality of virtual objects are mixed and/or merged and performs object separation according to various embodiments. The electronic device 100 may individually distinguish and use a plurality of voice objects using the artificial intelligence model 131. For example, the orchestra music sound 910 may be separated by instrument sound to raise or reduce the sound volume of specific instruments.

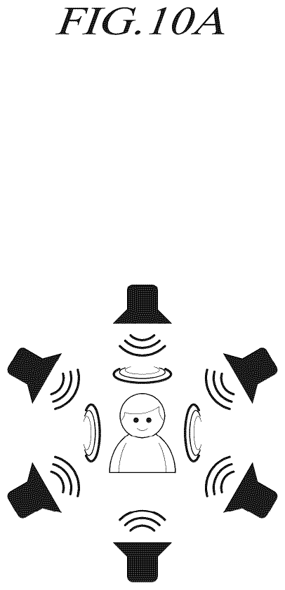

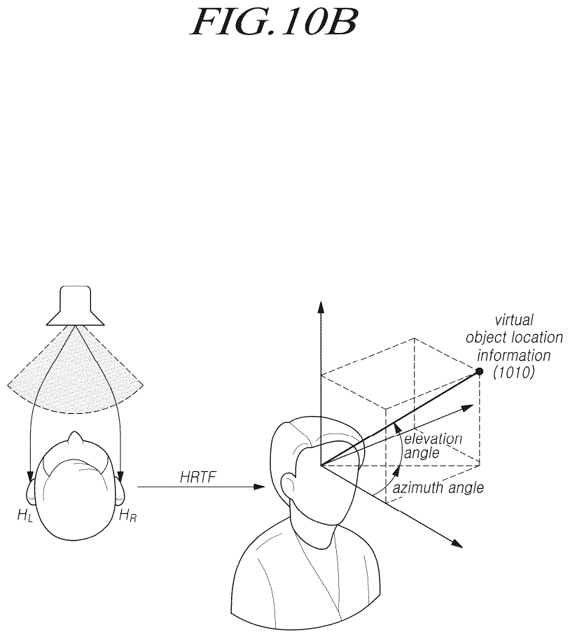

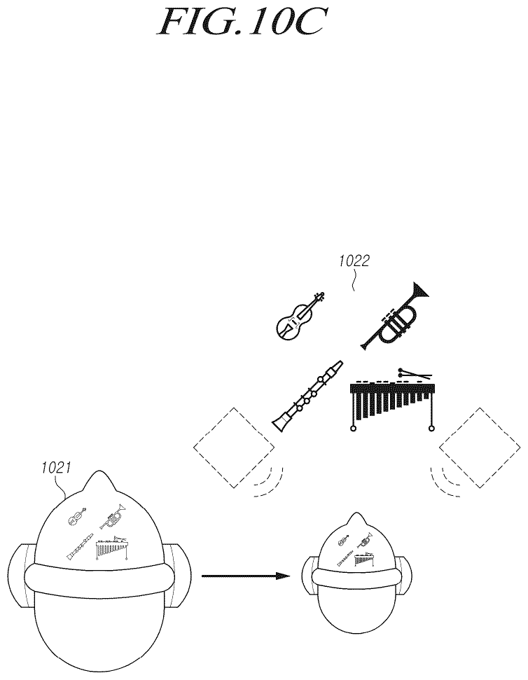

FIGS. 10A, 10B and 10C are diagrams illustrating an example in which an electronic device (e.g., the electronic device 100 of FIG. 1) separates, per object, at least one audio object and uses the same to simulate spatial audio according to various embodiments. In order to simulate spatial audio, the electronic device 100 may consider location information of at least one object individually separated. The location information may be location information included in the input audio data (e.g., a recording file recorded while recording location information by an array of a plurality of microphones), or may be virtually generated and/or allocated location information.

According to an embodiment, the spatial audio may be a technology that processes sound so that the user may hear the sound as if it had occurred at a specific location in a real or virtual three-dimensional space. The electronic device 100 may process the sound of a single audio object to sound as if it had occurred at a specific location by spatial audio technology, and may individually process the sounds of a plurality of audio objects to sound as if they had occurred at the same or different locations. The spatial audio may be simulated in hardware, software, or simultaneously using a hardware method and a software method.

Referring to FIG. 10A, according to an embodiment, the electronic device 100 may individually separate at least one audio object and then hardware-wise simulate spatial audio using location information of each object and a plurality of spatially divided audio output units. For example, the electronic device 100 may simulate spatial audio through a surround sound system such as 5.1 channels or 7.1 channels.

Referring to FIG. 10B, according to an embodiment, the electronic device 100 may individually separate at least one audio object and then simulate spatial audio using each object's location information and a head-related transfer function (HRTF) in software.

According to an embodiment, the head-related transfer function is a mathematical function representing how sound is changed by the body structure when it reaches the ear at a specific location in space, and may be used to make a simulation as if the sound is heard at a specific virtual location.

According to an embodiment, referring to FIG. 10B, the head-related transfer function may be divided into two transfer functions H, and H_{R}, H, and H_{R}, respectively, are functions that perform filtering on sounds reaching the left ear and the right ear, and may be functions that connect how sound changes and reaches compared to an omni-directional source according to the frequency, azimuth angle, and elevation angle of the sound. A person may accurately determine the position of a sound source in space through auditory cues, including the difference in sound arrival time between both ears, sound variations due to shielding or diffraction at the head, and sound changes due to the asymmetrical shape of the earflaps. H, and H_{R} may be functions that may be used to simulate virtual object location information 1010 by mathematically converting the auditory cues used by a person to determine the position of sound in space.

According to an embodiment, referring to FIG. 10C, 3D spatial audio may be simulated with only stereo audio (e.g., a two-channel headset) that physically has only two audio outputs using the HRTF. For example, by modeling the virtual position 1021 of audio objects through differences in arrival time, frequency, amplitude, and/or waveform of sounds at both ears, it may be made to feel as though the sound is actually coming from a specific position 1022 in space.

The various example embodiments described above may be simulated as software including instructions stored in a device-readable storage medium, in the form of a storage medium that is included in a computer program product and is readable by a device, or in a storage medium that may be distributed online through an application store or readable by a computer or a similar device using software, hardware, or a combination thereof.

Each component according to the various embodiments described above may be configured as a singular entity or plural entities, and some ancillary components may be omitted or further included. Some components may be integrated into a single entity, performing functions that are identical or similar to those executed by each respective component prior to integration.

The operations according to the various embodiments described above may be executed sequentially, in parallel, repetitively, or heuristically. Additionally, at least some operations may be executed in a different order, omitted, or other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
memory storing at least one instruction; and
at least one processor, comprising processing circuitry, wherein at least one processor, individually and/or collectively, is configured to cause the electronic device to:
convert first input data including input audio data for a first frame into a frequency domain to obtain first frequency data;
generate first mask data for audio object separation using the first frequency data;
delay the first frequency data by a first frame delay and apply the delayed first frequency data to the first mask data to obtain first frequency object data, the first frame delay being a number of frames related to a time taken to generate and apply mask data from the frequency data; and
convert the first frequency object data into a time domain to obtain first object data.

2. The electronic device of claim 1, wherein at least one processor, individually and/or collectively, is configured to cause the electronic device to: overlap an audio object data portion for the first frame included in the first object data and an audio object data portion for the first frame included in second object data to obtain first overlapping object data, and
wherein the second object data includes object data obtained before the first object data and includes audio object data for the first frame.

3. The electronic device of claim 2, wherein at least one processor, individually and/or collectively, is configured to cause the electronic device to obtain the overlapping object data for the first frame by performing the overlap by applying at least one window function to the audio object data portion for the first frame included in the first object data and the audio object data portion for the first frame included in the second object data.

4. The electronic device of claim 2, wherein the first object data is data stored in a buffer having a size that is an integer multiple of audio samples per frame, and includes data storing data including the audio object data for the first frame, and
wherein the second object data includes data stored in a buffer having a size that is an integer multiple of audio samples per frame, and includes data storing, in frame order, data including audio object data for a second frame following the first frame and at least one frame preceding the second frame, and the at least one frame preceding the second frame includes the first frame.

5. The electronic device of claim 1, wherein the first frequency data includes data stored in a buffer having a size that is an integer multiple of frequency components per frame, and includes data storing, in frame order, data including frequency components for the first frame and at least one frame preceding the first frame,
and wherein at least one processor, individually and/or collectively, is configured to cause the electronic device to:
store the first frequency data in a first storage space of a first-in-first-out structure in the memory, the first storage space being a storage space of a size requiring a time corresponding to the first frame delay from a time at which the first frequency data is input to a time at which the first frequency data is output; and
obtain the first frequency object data by applying the first mask data at the time at which the first frequency data is output from the first storage space.

6. The electronic device of claim 1, wherein at least one processor, individually and/or collectively, is configured to cause the electronic device to: delay input video data for the first frame by a second frame delay and output the input video data, and
wherein the second frame delay is a number of frames corresponding to a total number of delayed frames from a time at which audio data regarding the first frame is input to a time at which the audio data regarding the first frame is output.

7. The electronic device of claim 1, wherein the first input data includes data including a voice,
wherein the first object data includes voice object data in which the voice is separated, and
wherein at least one processor, individually and/or collectively, is configured to cause the electronic device to generate text corresponding to the first object data.

8. The electronic device of claim 1, wherein the first input data includes data including a voice in a first language,
wherein the first object data includes voice object data in which the voice in the first language is separated,
and wherein at least one processor, individually and/or collectively, is configured to cause the electronic device to:
generate text in the first language corresponding to the first object data;
generate text in a second language through machine translation from the text in the first language;
generate voice object data in the second language using a text-to-speech (TTS) model from the text in the second language; and
reduce a sound volume of the first object data and add the voice object data in the second language in the first input data.

9. The electronic device of claim 1, wherein the first input data includes data including a voice,
wherein the first object data includes voice object data in which the voice is separated, and
wherein at least one processor, individually and/or collectively, is configured to cause the electronic device to adjust or remove a sound volume of the first object data in the first input data.

10. The electronic device of claim 1, wherein at least one processor, individually and/or collectively, is configured to cause the electronic device to adjust or remove a sound volume of a remaining portion other than the first object data in the first input data.

11. The electronic device of claim 1, wherein the first input data includes data in which audio data of a plurality of objects are combined,
wherein the first object data individually includes audio data of a plurality of objects, and
wherein at least one processor, individually and/or collectively, is configured to cause the electronic device to separate, per object, the audio data of the plurality of objects included in the first object data.

12. The electronic device of claim 1, wherein the electronic device is configured to simulate a spatial audio in hardware and/or software, and
wherein the hardware simulation includes causing at least one processor, individually and/or collectively, to transfer different outputs for the first object data to a plurality of spatially separated audio output units, respectively, considering location information of an audio object, and
wherein the software simulation includes causing at least one processor, individually and/or collectively, to recognize a location and head direction of a user and generate, using a head-related transfer function (HRTF) on the first object data, output audio data considering the location information of the audio object and the location and head direction of the user.

13. A method of operating an electronic device, the method comprising:
receiving audio data for a first frame;
converting first input data including input audio data for a first frame into a frequency domain to obtain first frequency data;
generating first mask data for audio object separation using the first frequency data;
delaying the first frequency data by a first frame delay and applying the delayed first frequency data to the first mask data to obtain first frequency object data; and
converting the first frequency object data into a time domain to obtain first object data,
wherein the first frame delay is a number of frames related to a time taken to generate and apply mask data from the frequency data.

14. The method of claim 13, further comprising performing an overlap between an audio object data portion for the first frame included in the first object data and an audio object data portion for the first frame included in second object data,
wherein the second object data includes object data obtained before the first object data and includes audio object data for the first frame.

15. The method of claim 13, wherein the first object data includes data stored in a buffer having a size that is an integer multiple of audio samples per frame, and includes data storing data including the audio object data for the first frame, and
wherein the second object data includes data stored in a buffer having a size that is an integer multiple of audio samples per frame, and includes data storing, in frame order, data including audio object data for a second frame following the first frame and at least one frame preceding the second frame, and wherein the at least one frame preceding the second frame includes the first frame.

16. The method of claim 13, further comprising:
storing the first frequency data in a first storage space; and
obtaining the first frequency object data by applying the first mask data at the time at which the first frequency data is output from the first storage space,
wherein the first frequency data includes data stored in a buffer having a size that is an integer multiple of frequency components per frame, and includes data storing, in frame order, data including frequency components for the first frame and at least one frame preceding the first frame, and
wherein the first storage space includes a storage space having a first-in-first-out structure in memory of the electronic device and includes a storage space of a size requiring a time corresponding to the first frame delay from a time at which the first frequency data is input to a time at which the first frequency data is output.

17. The method of claim 13, further comprising:
receiving video data for the first frame; and
delaying and outputting input video data for the first frame by a second frame delay,
wherein the second frame delay is a number of frames corresponding to a total number of delayed frames from a time at which audio data regarding the first frame is input to a time at which the audio data regarding the first frame is output.

18. The method of claim 13, wherein the first input data includes data including a voice, and the first object data includes voice object data in which the voice is separated, and
wherein the method further comprises generating text corresponding to the first object data.

19. The method of claim 13, wherein the first input data includes data including a voice in a first language, and the first object data includes voice object data in which the voice in the first language is separated, and wherein the method further comprises:
generating text in the first language corresponding to the first object data;
generating text in a second language through machine translation from the text in the first language;
generating voice object data in the second language using a text-to-speech (TTS) model from the text in the second language; and
reducing a sound volume of the first object data and adding the voice object data in the second language in the first input data.

20. The method of claim 13, wherein the first input data includes data including a voice in a first language, and the first object data includes voice object data in which the voice in the first language is separated, and
wherein the method further comprises adjusting or removing a sound volume of the first object data in the first input data.
